(19) United States
(12) Patent Application Publication
(10) Pub. No.: US 2026/0024133 A1
(43) Pub. Date: Jan. 22, 2026

(54) MANAGING CHANGES WITHIN DATABASE FILE ENVIRONMENTS

(71) Applicant: Truist Bank, Charlotte, NC (US)

(72) Inventors: Jamie Nathaniel Franklin, Charlotte, NC (US); Mary Margaret Mueller, Charlotte, NC (US)

(73) Assignee: Truist Bank, Charlotte, NC (US)

(21) Appl. No.: 18/779,867

(22) Filed: Jul. 22, 2024

(51) Int. Cl. G06Q 40/02; G06Q 20/34

(52) U.S. Cl. CPC G06Q 40/02; G06Q 20/354

(57) ABSTRACT

A system and method managing changes within a database file environment include: a communication device operated by a user; a processor and a non-transitory storage device; and a change application stored in the storage device. The application causes the processor to: receive from the user via the communication device an active file number report being associated with a file stored in the storage device; process the report and generate a new file number; analyze activity information associated with the active file number, the activity information being stored in the file in the storage device, and generate a list of sources of recurring charges in the activity information; send the list of sources to the communication device and receive from the communication device a selection of at least one of the sources; and send a message to the at least one source, the message including the new file number.

### FIELD

This invention relates generally to the field of databases, and more particularly embodiments of the invention relate to methods and systems for payment card issuers to update card number changes for sources of goods and services making recurring charges.

### BACKGROUND

A significant number of financial transactions involve the use of credit and debit cards issued through financial enterprises such as retail and commercial banks. When such a card is lost or stolen, the card holder reports the event to the financial enterprise so that the current account is closed and a new card is issued with a different account number. “Stolen” can mean that the physical card was taken or that the account information enabling purchases was obtained by an unauthorized party. Although a new card is issued, the card holder may have authorized one or more sources of goods and/or services to make recurring charges to the original card account number to pay for items such as telephone bills, utility bills, car payments, and magazine subscriptions. Unless the card holder notifies a source about the new account number, subsequent charges to the original account number will be denied. At a minimum, the card holder will be inconvenienced and the source could suspend the delivery of goods or services.

The methods and systems according to the invention described herein reduce the problems associated with a change in the credit or debit card account number due to a lost or stolen card.

### BRIEF SUMMARY

The systems and methods of the invention described herein solve the above-identified problems.

In an embodiment of the invention, a system for managing changes within a database file environment comprises: a communication device operated by a user having an active file number; a processor and a non-transitory storage device operatively coupled for communication with the communication device; and a change application stored in the storage device. The application includes executable code that, when executed, causes the processor to: receive from the user via the communication device a report related to the active file number, the active file number being associated with a file stored in the storage device; process the report and generate a new file number; analyze activity information associated with the active file number, the activity information being stored in the file in the storage device, and generate a list of sources of recurring charges in the activity information; send the list of sources to the communication device and receive from the communication device a selection of at least one of the sources; and send a message to the at least one source, the message including the new file number.

The active file number and the new file number can be card account numbers. The report includes information that a card associated with the active file number has been lost or stolen. The processor sends a message to the communication device, the message including the new file number. The processor generates a new card associated with the new file number.

The processor analyzes the activity information over a predetermined time period for monthly charges that: occur on a common date; are of a common amount; are from a common source name; and/or are associated with an installment sale.

The processor receives from the communication device a selection of all of the sources, and sends the message to all of the sources. In the alternative, the processor receives from the communication device a selection of less than all of the sources, and sends the message to the selected sources.

In another embodiment of the invention, a method of managing changes within a database file environment comprises steps of: providing a processor and a non-transitory storage device operatively coupled for communication with a communication device of a user, the user having an active file number; and storing a change application in the storage device, the application including executable code that is executed by the processor.

The change application causes the processor to: receive from the user via the communication device a report related to the active file number, the active file number being associated with a file stored in the storage device; process the report and generate a new file number; analyze activity information associated with the active file number, the activity information being stored in the file in the storage device; generate a list of sources of recurring charges in the analyzed activity information; send the list of sources to the communication device; receive from the communication device a selection of at least one of the sources; and send a message to the at least one source, the message including the new file number.

The active file number and the new file number can be card account numbers. The report can include information that a card associated with the active file number has been lost or stolen.

The method includes sending a message to the user through the communication device, the message including the new file number. The method includes generating a new card associated with the new file number.

The method includes analyzing the activity information over a predetermined time period for monthly charges that: occur on a common date; are of a common amount; are from a common source name; and/or are associated with an installment sale.

The method includes receiving from the communication device a selection of all of the sources, and sending the message to all of the sources. In the alternative, the method includes receiving from the communication device a selection of less than all of the sources, and sending the message to the selected sources.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates an enterprise system, and environment thereof, according to at least one embodiment.

FIG. 2 is a flow diagram representing a method, according to at least one embodiment, of managing changes in a database of payment card files according to an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

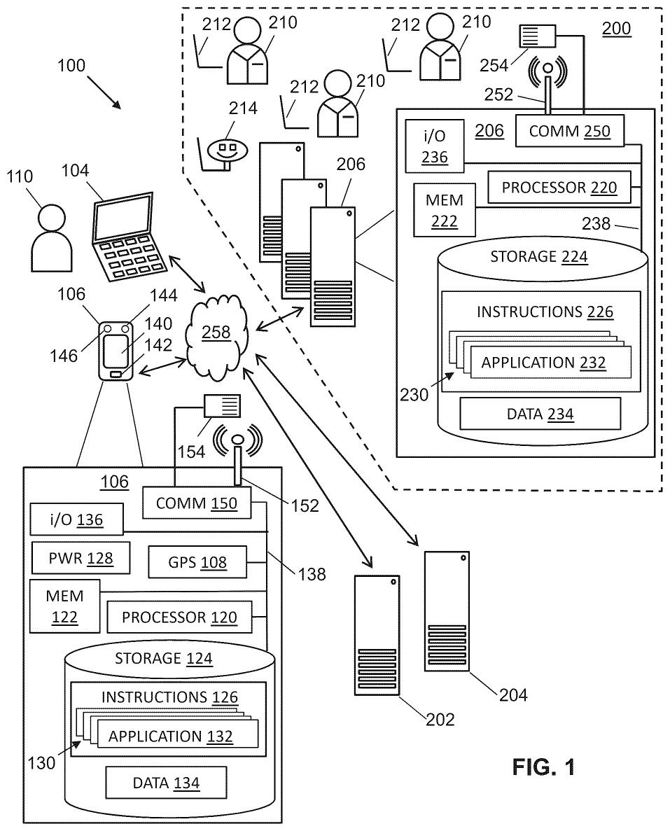

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P transaction system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system user application from a mobile banking system, for example enterprise system 200, or from a distinct application server. In other embodiments, the user 110 interacts with a mobile banking system via a web browser application in addition to, or instead of, the mobile P2P transaction system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include an interface. The network interface may include software, such as encryption software, and hardware, such as a modem, for communicating information to and/or from one or more devices on a network. For example, the mobile device 106 may be configured so that it can be used as a user device by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, account cards, automatic-teller machines, loans, mortgages, personal accounts, business accounts, account management, and credit reporting, requests and scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent transaction clearinghouse or transaction rail systems for processing transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

A significant number of financial transactions involve the use of payment cards, credit and debit, issued through financial enterprises such as retail and commercial banks. When a payment card is lost or stolen, the card holder reports the event to the financial enterprise so that the current account is closed and a new payment card is issued with a different account number. “Stolen” can mean that the physical card was taken or that the account information enabling purchases was obtained by an unauthorized party. Although a new payment card is issued, the card holder may have authorized one or more sources of goods and/or services to make recurring charges to the original payment card account to pay for items such as telephone bills, utility bills, car payments, and magazine subscriptions. Unless the card holder notifies a source about the new account number, subsequent charges to the original account number will be denied. At a minimum, the card holder will be inconvenienced and the source could suspend the delivery of goods or services.

The methods and systems according to the invention described herein reduce the problems associated with a change in the payment card account number due to a lost or stolen card. The invention is described below in the context of a bank issued payment card. However, the described methods and systems also apply to any enterprise that issues debit and credit cards. The user 110, shown in FIG. 1, who is the holder of an active payment card uses the computing device 104 and/or the mobile device 106 to manage the card account via an online banking application stored in the storage device 224 as one of the applications 232. Online banking applications typically enable the user to manage all types of accounts including checking, saving, credit card, debit card and loans.

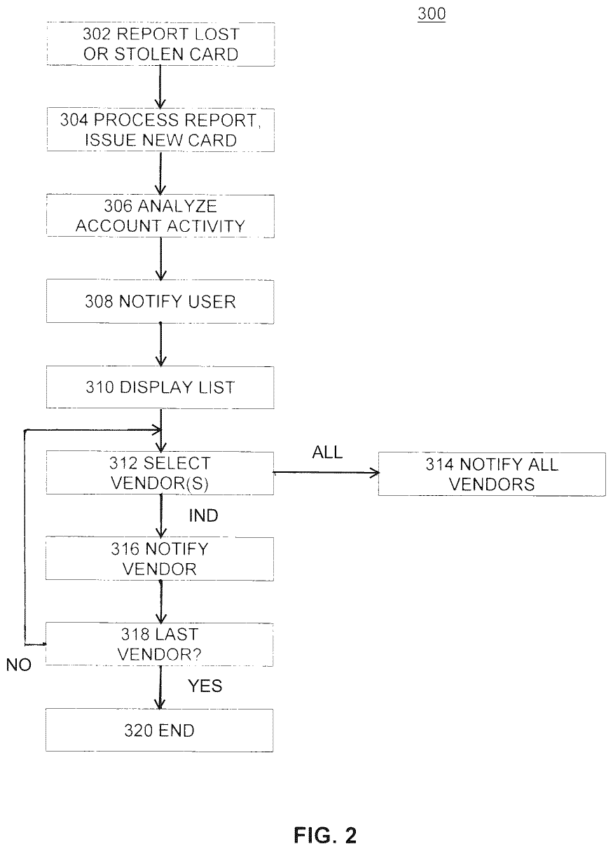

FIG. 2 is a flow diagram representing a method 300, according to at least one embodiment of the invention, for managing changes within a database file environment. In the following, the term “card” will be used to refer to credit and debit type payment cards. The method 300 facilitates notifying a source of change in the card account number used for recurring payments. The method 300 can be performed by the computing system 206 using a change application stored as one of the applications 232 in the storage device 224, or the change application can be incorporated in the online banking application discussed above. The change application includes executable code that, when executed by the processor 220, performs the steps described below.

In a step 302, the user 110 (holder) of an active card reports to the card issuing bank that the card has been lost or stolen. The reporting can be done by telephone or online using the computing device 104 or the mobile device 106. In the following description, the devices 104, 106 are referred to as a communication device. In a step 304, the bank processes the lost or stolen card report to result in the closing of the active card account and the issuing of a new card with a new account number. This procedure results in the denial of any subsequent charge requests using the number of the closed account.

In a step 306, the change application analyzes the previous activity in the closed card account to identify sources that made recurring charges during a predetermined time period. Information about the previous activity is included in the other data 234 under an active file number referenced to the active cared account number and stored in the storage device 224. Criteria for identifying recurring charges can include the same or approximately the same each month of: date, amount, and source name. Further, the bank can have a file of sources for which the card account number is stored. Also, the bank can have stored information provided by the source that is related to payments for an installment sale such as a vehicle loan.

In a step 308, the bank notifies the user 110 that recurring charges have been identified and that the user can access the change application through the communication device 104, 106 to notify the sources as to the new card account number. In a step 310, the user 110 connects to the computing system 206 and the change application displays the list of identified sources on the communication device 104, 106.

In a step 312, the user 110 has the option to notify all of the identified sources and the option to select individual sources for notification. If the user selects ALL, the method branches to a step 314 in which the bank notifies all of the sources in the list of the new card account number to be used for the associated recurring charge. If the user selects IND, the method branches to a step 316 wherein the user 110 selects one of the sources from the list and the bank notifies the selected source of the new card account number to be used for the associated recurring charge. In a step 318, if the user indicates that the last source selection has been made, the method branches at YES to a step 320 to close the change application.

In the step 318, if the user indicates that the last source selection has not been made, the method braches at NO back to the step 314 for another selection. Instead of selecting and notifying sources one-by-one, the step 314 can permit the user 110 to mark all of the selected sources that are then notified in the step 316.

The above-described systems and methods significantly reduce the inconvenience and effort associated with notifying recurring charge sources of a new card account number because an active card was lost or stolen.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

1. A system for managing changes within a database file environment, the system comprising:
a communication device operated by a user having an account with an active file number;
a processor and a non-transitory storage device operatively coupled for communication with the communication device, storing in the storage device a plurality of files, each of the files being associated with a unique file number, the files including a user file associated with the active file number of the user; and
a change application stored in the storage device, the application including executable code that, when executed, causes the processor to:
receive from the user via the communication device a report related to the active file number of the user;
process the report and, in response to information in the report that a card associated with the active file number has been lost or stolen, close the account associated with the active file number such that subsequent charge requests using the active file number are denied;
generate a new file number and issue to the user a new card associated with the new file number;
analyze activity information in the user file associated with the active file number, the activity information being stored in the user file in the storage device, and generate a list of sources of recurring charges in the activity information;
send the list of sources to the communication device and receive from the communication device a selection of at least one of the sources; and
send a message to the at least one source, the message including the new file number.

2. The system according to claim 1 wherein the active file number and the new file number are card account numbers.

3. (canceled)

4. The system according to claim 1 wherein the processor sends a message to the communication device, the message including the new file number.

5. (canceled)

6. The system according to claim 1 wherein the processor analyzes the activity information over a predetermined time period for monthly charges that: occur on a common date; are of a common amount; are from a common source name; and/or are associated with an installment sale.

7. The system according to claim 1 wherein the processor receives from the communication device a selection of all of the sources, and sends the message to all of the sources.

8. The system according to claim 1 wherein the processor receives from the communication device a selection of less than all of the sources, and sends the message to the selected sources.

9. A method of managing changes within a database file environment, the method comprising steps of:
providing a processor and a non-transitory storage device operatively coupled for communication with a communication device of a user, the user having an account with an active file number;
storing a plurality of files in the storage device, each of the files being associated with a unique file number, the files including a user file associated with the active file number of the user;
storing a change application in the storage device, the application including executable code that is executed by the processor causing the processor to:
receive from the user via the communication device a report related to the active file number of the user;
process the report and, in response to information in the report that a card associated with the active file number has been lost or stolen, close the account associated with the active file number such that subsequent charge requests using the active file number are denied;
generate a new file number and issue to the user a new card associated with the new file number;
analyze activity information in the user file associated with the active file number, the activity information being stored in the user file in the storage device;
generate a list of sources of recurring charges in the analyzed activity information;
send the list of sources to the communication device;
receive from the communication device a selection of at least one of the sources; and
send a message to the at least one source, the message including the new file number.

10. The method according to claim 9 wherein the active file number and the new file number are card account numbers.

11. (canceled)

12. The method according to claim 9 including sending a message to the user through the communication device, the message including the new file number.

13. (canceled)

14. The method according to claim 9 including analyzing the activity information over a predetermined time period for monthly charges that: occur on a common date; are of a common amount; are from a common source name; and/or are associated with an installment sale.

15. The method according to claim 9 including receiving from the communication device a selection of all of the sources, and sending the message to all of the sources.

16. The method according to claim 9 including receiving from the communication device a selection of less than all of the sources, and sending the message to the selected sources.
